(19) United States
(12) Patent Application Publication
(10) Pub. No.: US 2015/0195334 A1
(43) Pub. Date: Jul. 9, 2015

(54) REMOTE USER INTERFACE FOR SELF-SERVICE COMPUTING DEVICE

(71) Applicant: INTEL CORPORATION, SANTA CLARA, CA (US)

(72) Inventor: Yen Hsiang Chew, Georgetown (MY)

(21) Appl. No.: 14/124,234

(22) PCT Filed: Jun. 17, 2013
(86) PCT No.: PCT/US2013/046116

§ 371 Date: Dec. 5, 2013

(51) Int. Cl. H04L 29/08; G06Q 20/18; H04W 4/00; G06Q 20/10; G06F 3/0482; G06F 3/0484

(52) U.S. Cl. CPC H04L 67/025; G06F 3/0482; G06F 3/04842; H04L 67/16; H04W 4/008; G06Q 20/102; G06Q 20/18

(57) ABSTRACT

Embodiments of computer-implemented methods, systems, apparatuses, and computer-readable media (transitory and non-transitory) are described herein for configuring a self-service computing device to provide, to a remote computing device in direct wireless communication with the self-service computing device, data for the remote computing device to render an instance of a user interface operable by a user of the remote computing device to select a product or service offered by the self-service computing device. Other embodiments may be described and/or claimed.

### FIELD

Embodiments of the present invention relate generally to the technical field of data processing, and more particularly, to rendition of user interfaces for a self-service computing device by remote computing devices.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Self-service computing devices may be utilized to offer and/or dispense products and/or services. These devices typically may include an integral user interface that a user may operate to purchase a good or service offered by the device. For example, a vending machine may include a user interface in the form of a touchpad, a plurality of buttons, and so forth, that is usable by a user to select a product (e.g., snacks, electronics, etc.) or service (e.g., massage, video call, etc.) offered by the vending machine. As another example, a kiosk at an airport, train station or bus station may include a touch screen that is usable by passengers to purchase tickets, change reservations, upgrade seats, etc. Many such self-service computing devices have mechanisms for paying for selected goods or services, such as credit and debit card readers, cash/coin acceptance mechanisms, and so forth.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a self-service computing device and remote computing device, in accordance with various embodiments.

FIG. 2 schematically illustrates example operations that may be performed by a self-service computing device and a remote computing device, in accordance with various embodiments.

FIG. 3 schematically illustrates an example queue, in accordance with various embodiments.

FIG. 4 schematically depicts an example computing device on which disclosed methods and computer-readable media may be implemented, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

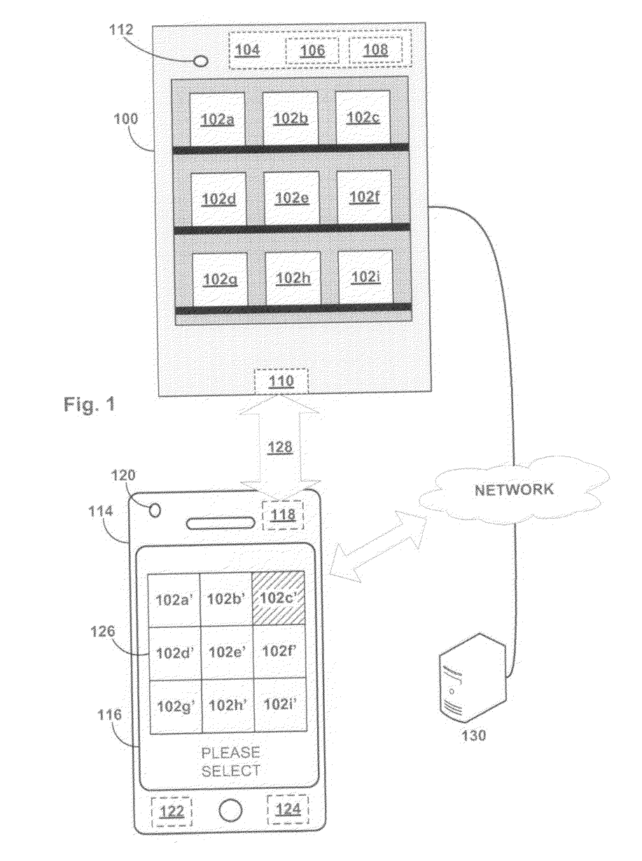

Referring to FIG. 1, an example self-service computing device 100, in accordance with various embodiments, is depicted in the form of a vending machine offering products 102a-i. However, this is not meant to be limiting. As used herein, a “self-service computing device” may refer to any data processing device associated with any unit that offers any products or services without requiring a human being to “man” the unit. In addition to vending machines, in some embodiments, self-service computing devices may include ticket kiosks that are configured to facilitate purchase, cancellation, upgrade or downgrade of tickets associated with air travel, train travel, bus travel, other vehicle travel, entertainment events such as concerts or movies, sporting events, and so forth.

The type of product offered/dispensed is not material. For example, products 102a-i may be any type of product, including but not limited to snacks or other foodstuffs, candy, electronics, tickets, toys, media (e.g., books, compact disks, digital versatile disks, Blueray disks, etc.) and so forth. While products 102a-i are depicted as physical products in FIG. 1, this is not meant to be limiting, and products 102a-i may additionally or alternatively be “virtual” products, such as e-tickets, e-books, multimedia downloads, computer game downloads, units of electrical power (e.g., to quickly charge a mobile phone), temporal units (e.g., for provision of massage, electrical power), and so forth.

In various embodiments, self-service computing device 100 may include a self-service engine 104. In various embodiments, self-service engine 104 may include a user interface (“UI”) provider module 106 and/or a dispenser module 108. In various embodiments, self service engine 104, UI provider module 106 and/or dispenser module 108 may be implemented using any combination of hardware and software.

In various embodiments, UI provider module 106 may be configured to provide, to one or more remote computing devices in direct wireless communication with self-service system 100, data for the remote computing devices to render instances of a user interface operable by one or more users of the one or more remote computing devices to select a product or service (e.g., 102a-i) offered by self-service system 100. Dispenser module 108 may be configured to dispense a product or service selected by one or more users with remote computing devices. These modules will be discussed in more detail below.

Self-service computing device 100 may also include at least one wireless interface 110 configured to facilitate direct wireless communication with one or more remote computing devices such as mobile smart phones and tablets. To communicate “directly” as used herein may refer to communication without an intermediary device such as a base station or WiFi access point. Thus, wireless interface 110 may come in various forms. In some embodiments, wireless interface 110 may be a radio frequency identification (“RFID”) component configured to transmit and/or receive RFID signals. In some embodiments, wireless interface 110 may be a near field communication (“NFC”) component configured to transmit and/or receive NFC signals. In some embodiments, wireless interface 110 may be a WiFi component configured to transmit and/or receive WiFi signals, including WiFi Direct.

In some embodiments, wireless interface 110 may be a Quick Response (“QR”) code that may be read optically by a remote computing device. In some such embodiments, wireless interface 110 may therefore be passive. However, in some embodiments, self-service computing device 100 may include a camera 112 or other component configured to capture optical data, e.g., from a mobile phone. For instance, a mobile phone may render, e.g., on a touch screen display, an image of a QR code that may be “read” by camera 112 and interpreted by self-service computing device 100.

In FIG. 1, an example remote computing device is depicted in the form of a mobile computing device 114, e.g., a smart phone or tablet. Mobile computing device 114 may include a display 116, which in some embodiments may be a touch screen display, though this is not required. Mobile computing device 114 may also include a wireless interface 118 that may be configured to communicate directly with wireless interface 110 of self-service computing device 100. In various embodiments, mobile computing device 114 may additionally or alternatively include a camera 120 configured to capture image data, such as a QR code on self-service computing device 100.

In various embodiments, mobile computing device 114 may include a UI implementation module 122 and a payment module 124, either of which may be implemented with any combination of hardware and software. In various embodiments, UI implementation module 122 may be configured to render a UI 126 on display 116. In FIG. 1, UI 126 includes selectable elements 102a′-i′ that correspond to products 102a-i. A user may be able to operate UI 126 to select one or more selectable elements 102a′-i′, and hence, one or more products 102a-i, for purchase.

In various embodiments, mobile computing device 114 may be used to interact with self-service computing device 100, e.g., to purchase one of products 102a-i, in various ways. In some cases, a user may bring mobile computing device 114 into within a predetermined distance of self-service computing device 100, e.g., close enough for NFC/RFID/WiFi Direct communications. Wireless interface 110 and/or 118 may detect the presence of the other (e.g., using a beacon signal) and may initiate a handshake procedure to establish direct wireless communication, as indicated by arrow 128.

Once direct wireless communication is established, self-service computing device 100 may provide mobile computing device 114 with data associated with UI 126. Using this data, mobile computing device 114 may then render an instance of UI 126 operable by a user of mobile computing device 114 to select a product 102a-i offered by self-service computing device 100. For example, in FIG. 1, a selectable element 102c′ (top right) is active on UI 126. If a user wishes to purchase the corresponding product 102c, the user may provide appropriate input, such as pressing a “select” button (not shown), providing a voice command, moving mobile device 114 in a predetermined manner that corresponds to a command, and/or tapping selectable element 102c′.

Mobile computing device 114 may communicate a user selection to self-service computing device 100 in various ways. In some embodiments, mobile computing device 114 may provide data indicative of the user's selection, e.g., to a remote computing server 130 in network communication with self-service computing device 100, e.g., over one or more local area, wide area and/or wireless wide area networks. In such case, remote computing server 130 may then provide the data indicative of the user's selection to self-service computing device 100. In some cases, remote computing server 130 may implement all or a portion of a “cloud.” In other embodiments, mobile computing device 114 may provide data indicative of the user's selection directly to self-service computing device 100, e.g., using RFID, NFC, WiFi Direct, QR Code, etc.

Assuming self-service computing device 100 has the selected product 102c in its inventory, dispenser module 108 may facilitate a payment transaction with mobile computing device 114. For example, to initiate payment, a user may tap mobile computing device 114 against self-service computing device 100. This may cause one or more direct wireless (e.g., NFC) payment communications to be exchanged between dispenser module 108 and mobile computing device 114. For example, dispenser module 108 may obtain a payment from payment module 124. In various embodiments, payment module 124 may provide payment directly to dispenser module 108, e.g., via wireless interfaces 110 and 118. Additionally or alternatively, payment module 124 may provide payment indirectly to dispenser module 108, e.g., through a remote computing server 130 (e.g., PayPal®).

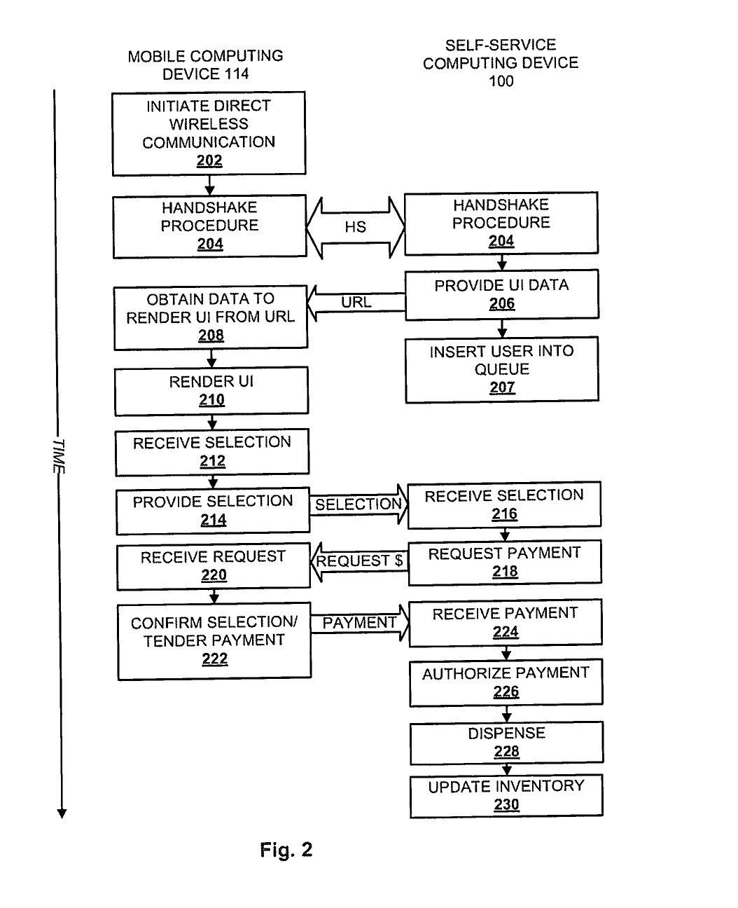

Example operations that may be performed by mobile computing device 114 and self-service computing device 100 to conduct a transaction of a product or service are shown in FIG. 2. At block 202, mobile computing device 114 may be used to initiate direct wireless communication with self-service computing device 100. For instance, mobile computing device 114 may be tapped against self-service computing device 100. Enabling initiation of direct wireless communication using tapping or other techniques that do not require physical contact with self-service computing device 100 may reduce the spread of bacteria, viruses and other germs. It may also increase users' ability to make selections in privacy. In various embodiments, once direct wireless communication is established, at block 204, mobile computing device 114 and self-service computing device 100 may conduct a direct wireless communication handshake (“HS”) procedure.

At block 206, self-service computing device may provide data associated with UI 126 to mobile computing device 114. For instance, in various embodiments, UI provider module 106 may be configured to provide, to mobile computing device 114 using direct wireless communication (e.g., RFID, NFC, WiFi Direct, QR code, etc.), a universal resource locator (“URL”). The URL may be accessible by remote computing device 114 at block 208 to obtain data configured to enable remote computing device 114 to render an instance of IU 126. In some embodiments, the URL may be the location of a webpage, and UI implementation module 122 may include a web browser configured to obtain markup language (e.g., HTML, XML) from a web server identified by the URL and render, as UI 126, a webpage on display 116. In other embodiments, at arrow 206, UI provider module 106 of self-service computing device 100 may simply provide, directly to UI implementation module 122 using RFID, NFC, WiFi Direct, etc., all the data necessary for to render UI 126.

In various embodiments, the UI data provided by self-service computing device 100 to mobile computing device 114, e.g., by way of UI provider module 106 to UI implementation module 122, may be dependent on capabilities of mobile computing device 114. For example, if mobile computing device 114 has a very small display 116 or limited graphics capabilities, the data may be usable to render an instance of UI 126 that is relatively simple, e.g., in black and white and/or text only. In contrast, if mobile computing device 114 has more robust capabilities and/or a larger display 116, then the data may be usable to render an instance of UI 126 that is relatively complex, e.g., with pictures, sound, video, animations, and so forth.

At block 210, mobile computing device, e.g., via UI implementation module 122, may render an instance of UI 126. In some embodiments, a session ID may be associated, e.g., by self-service computing device 100, remote server 130 and/or mobile computing device 114, with this rendering operation. In various embodiments, the session ID may be used by various entities in subsequent operations, such as user selection, payment, and dispensing. For instance, the session ID may be incorporated into subsequent communications between self-service computing device 100 and mobile computing device 114.

At block 212, UT implementation module 122 may receive one or more user selections of products, e.g., from a user providing input to UI 126 on a touch screen. At block 214, mobile computing device 114, e.g., by way of UI implementation module 122, may provide data indicative of the user selection to self-service computing device 100, e.g., using RFID, NFC, WiFi Direct, etc. As noted above, in other embodiments, this data may additionally or alternatively be provided to a remote computing server (e.g., 130), which may in turn pass the data (or another command, e.g., “dispense,” “request payment,” etc.) on to self-service computing device 100. In various embodiments, UI implementation module 122 may include the aforementioned session ID with the data indicative of the user's selection. At block 216, self-service computing device 100, e.g., by way of UI provider module 106 and/or dispenser module 108, may receive the data indicative of the user selection, as well as the session ID if included.

At block 218, self-service computing device 100, e.g., via dispenser module 108, may request payment from payment module 124 of mobile computing device 114. At block 220, payment module 124 of mobile computing device 114 may receive the request for payment. At block 222, payment module 124 may confirm the user selection and/or tender payment. In some embodiments, block 222 is performed by payment module in response to a user action, e.g., tapping mobile computing device 114 against self-service computing device 100 again. In other embodiments, block 222 is performed automatically upon receipt of the request for payment at block 220. In either case, payment module 124 may include the session ID with the confirmation/tender of payment.

In FIG. 2, payment is tendered directly to dispenser module 108 of self-service computing device 100 by mobile computing device 114, e.g., by way of payment module 124, e.g., using RFID, NFC, Wifi Direct, etc. For example, the payment may be debited from an e-wallet implemented on mobile computing device 114. However, in some embodiments, payment may be tendered directly to self-service computing device 100 using other means, such as a credit or debit card carried by the user with RFID/NFC technology. In some embodiments, the user may simply insert cash and/or coins into various components of self-service computing device 100.

However, in other embodiments, payment may be tendered indirectly to self-service computing device 100. For example, payment module 124 of mobile computing device 114 may authorize a payment to be tendered, e.g., through remote computing server 130 in FIG. 1 (e.g., PayPal®), to an entity that is associated with self-service computing device 100.

At block 224, self-service computing device 100, e.g., by way of dispenser module 108, may receive the payment. Although in FIG. 2, dispenser module 108 of self-service computing device 100 receives payment directly from payment module 124 of mobile computing device 114, as noted above, in various embodiments, dispenser module 108 may receive payment (or an indication that payment was tendered elsewhere) indirectly, e.g., from a remote computing service 130 in communication with mobile computing device 114.

At block 226, self-service computing device 100, e.g., by way of dispenser module 108, may authorize the payment. For example, if payment was made by using a third party payment service such as PayPal®, dispenser module 108 may verify, e.g., with a PayPal® server, that the payment was properly made and authorized. Assuming the payment is authorized, at block 228, self service computing device 100, e.g., by way of dispenser module 108, may dispense the selected product or service.

In various embodiments, at block 230, self-service computing device 100, e.g., by way of dispenser module 108, may update its inventory to reflect that the product or service was dispensed. In some embodiments, dispenser module 108 of self-service computing device 100 may track its own inventory, and update the inventory upon dispensing a product or service, or upon being restocked with additional products or services. In other embodiments, dispenser module 108 of self-service computing device 100 may have its inventory tracked elsewhere, e.g., on a third party remote computing server (e.g., 130 in FIG. 1). In such case, dispenser module 108 of self-service computing device 100 may inform the third party server whenever self-service computing device 100 dispenses or is resupplied with a product or service. In some embodiments where dispenser module 108 itself tracks inventory of self-service computing device 100 (in addition to or instead of tracking done elsewhere), dispenser module 108 may automatically inform a third party (e.g., using email or other electronic means) when inventory drops below a predetermined threshold.

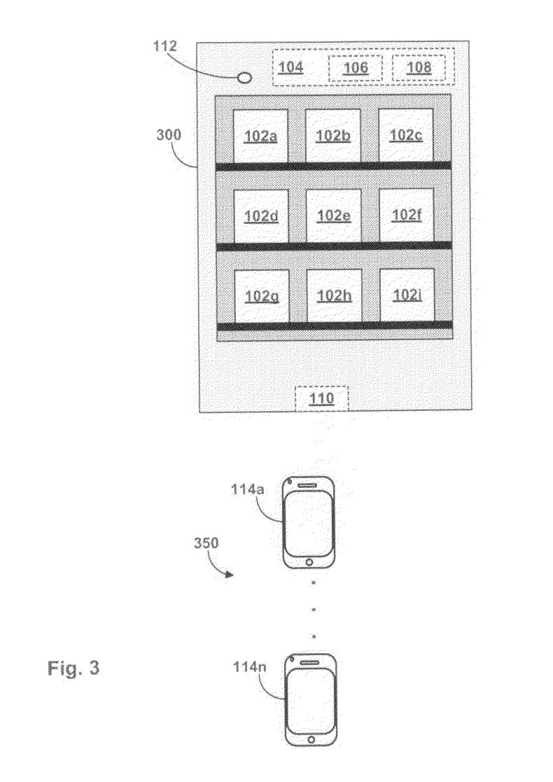

In various embodiments, in addition to providing data for rendition of UI 126 on remote computing devices such as mobile computing device 114, self-service computing device 100 may further be configured to perform queue management and enforcement. In FIG. 3, a plurality of mobile computing devices 114a-n are formed into a queue 350 in front of self-service computing device 100. In some cases, only mobile computing devices closest to self-service computing device 100 (e.g., those as the “front of the line”) may be within a close enough proximity of self-service computing device 100 to communicate with it directly using wireless communication technology (e.g., RFID, NFC, WiFi Direct, etc.). As noted above, in some cases, communication may not be initiated between self-service computing device 100 and a mobile computing device 114 until the mobile computing device is tapped against self-service computing device 100.

In various embodiments, dispenser module 108 of self-service computing device 100 may be configured to selectively dispense products or services among users for which UI provider module 106 has provided data for rendition of an instance of the UI 126 interface. The selective dispensing may be performed in various ways. In some embodiments, selective dispensing may be performed to enforce a queue. If two users select and/or attempt to purchase the same good or service, the good or service may be selectively dispensed, e.g., by dispenser module 108 of self-service computing device 100, based on which user arrived first. In some embodiments, dispenser module 108 may be configured to selectively dispense a product or service based on an order in which self-service computing device 100 commenced direct wireless communication with two or more mobile computing devices. For example, if a first user tapped her mobile phone against a vending machine before a second user, and both the first and second users order the same product, dispenser module 108 of self-service computing device 100 may dispense the selected product or service to the first user.

In some embodiments, dispenser module 108 may be configured to selectively dispense a product or service based on an order in which self-service computing device 100 receives indications that multiple users have operated respective instances of UI 126 to select a product or service offered by self-service computing device 100. In some embodiments, dispenser module 108 may be configured to selectively dispense a product or service based on an order in which self-service computing device 100 receives indications that multiple users have tendered payment for a selected a product or service offered by self-service computing device 100.

The selective dispensing described may eliminate or reduce the need for physical queues of users. For example, if a plurality of users have tapped their smart phones against self-service computing device 100 to establish an order of users, then those users need not stand in line when selecting a product or service. Instead, they may disperse and select a product or service at their convenience. Whether or not a particular user receives the product or service she selected may depend on the order in which she tapped her smart phone against self-service computing device, an order in which she selected the product or service, and/or an order in which she tendered payment for the product or service.

In another aspect, in various embodiments, self-service computing device 100, e.g., by way of UI provider module 106, may be configured to provide, e.g., to mobile computing device 114 using direct wireless communication, data for the remote computing device to render a personalized content. In various embodiments, the personalized content may be based on characteristics of a user captured by the self-service computing device 100, e.g., using camera 112. In some embodiments, personalized content may include various types of content, including but not limited to advertisements in any form (e.g., video, audio, images, textual, etc.), promotions, political messages, and so forth.

In yet another aspect, in various embodiments, self-service computing device 100, e.g., by way of dispenser module 108, may track user selections and/or purchases for purposes of marketing research. For instance, dispenser module 108 may track products sold, and may provide that data to remote computing device (which as mentioned above may be used to implement all or a portion of a cloud). This data may be used to determine an effectiveness of self-service computing device 100 (e.g.: Is it in a good location? Would it be more heavily utilized elsewhere?) as well as the popularity of a particular product, service or brand.

In some embodiments, self-service computing device 100 may be equipped with Audience Impression Matrix (“AIM”) or similar technology. Such technology may enable self-service computing device 100 to obtain (e.g., using camera 112) characteristics of a user, such as age, gender, and so forth, and to generate and provide to mobile computing device 114 personalized content. Thus, for instance, if self-service computing device 100 determines that a user is a male, self-service computing device may selectively present advertisements for some products or services, e.g., those of more interest to males, and not others. As another example, if a user appears to be below a particular age, self-service computing device 100, e.g., by way of UI provider module 106, may refrain from providing data that, when rendered on mobile computing device 114, would enable the user to select or view advertisements related to age-restricted products such as tobacco, alcohol or adult products.

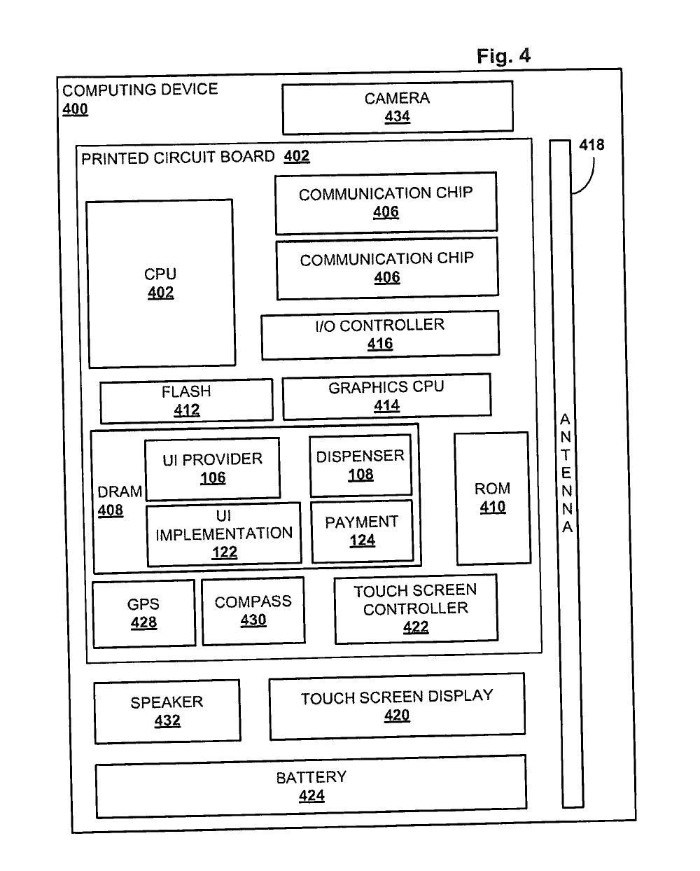

FIG. 4 illustrates an example computing device 400, in accordance with various embodiments. Computing device 400 may include a number of components, plurality of processors 402 and, in some cases, one or more communication chips 406. In various embodiments, the processors 402 may be processor cores. In various embodiments, the communication chips 406 may also be physically and/or electrically coupled to the processors 402. In further implementations, the communication chips 406 may be part of processors 402. In various embodiments, computing device 400 may include printed circuit board (“PCB”) 402. For these embodiments, processors 402 and communication chips 406 may be disposed thereon. In alternate embodiments, the various components may be coupled without the employment of PCB 402.

Depending on its applications, computing device 400 may include other components that may or may not be physically and electrically coupled to the PCB 402. These other components include, but are not limited to, volatile memory (e.g., dynamic random access memory 408, also referred to as “DRAM”), non-volatile memory (e.g., read only memory 410, also referred to as “ROM”), flash memory 412, a graphics processor 414, an input/output controller 416, a digital signal processor (not shown), a crypto processor (not shown), one or more antenna 418, a display (not shown), a touch screen display 420, a touch screen controller 422, a battery 424, an audio codec (not shown), a video codec (not shown), a global positioning system (“GPS”) device 428, a compass 430, an accelerometer (not shown), a gyroscope (not shown), a speaker 432, a camera 434, and a mass storage device (such as hard disk drive, a solid state drive, compact disk (“CD”), digital versatile disk (“DVD”))(not shown), and so forth. In various embodiments, processors 402 may be integrated on the same die with other components to form a System on Chip (“SoC”).

In various embodiments, volatile memory (e.g., DRAM 408), non-volatile memory (e.g., ROM 410), flash memory 412, and the mass storage device may include programming instructions configured to enable computing device 400, in response to execution by processors 402, to practice all or selected aspects of the operations depicted in FIG. 2, depending on whether computing device 400 is used as a self-service computing device 100 or a mobile computing device 114. For example, one or more of the memory components such as volatile memory (e.g., DRAM 408), non-volatile memory (e.g., ROM 410), flash memory 412, and the mass storage device may include temporal and/or persistent copies of UI provider module 106, dispenser module 108, UI implementation module 122 and/or payment module 124, e.g., to practice all or selected aspects of FIG. 2.

The communication chips 406 may enable wired and/or wireless communications for the transfer of data to and from the computing device 400. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Most of the embodiments described herein include WiFi and LTE RAT as examples.

However, the communication chip 406 may implement any of a number of wireless standards or protocols, including but not limited to IEEE 402.20, General Packet Radio Service (“GPRS”), Evolution Data Optimized (“Ev-DO”), Evolved High Speed Packet Access (“HSPA+”), Evolved High Speed Downlink Packet Access (“HSDPA+”), Evolved High Speed Uplink Packet Access (“HSUPA+”), Global System for Mobile Communications (“GSM”), Enhanced Data rates for GSM Evolution (“EDGE”), Code Division Multiple Access (“CDMA”), Time Division Multiple Access (“TDMA”), Digital Enhanced Cordless Telecommunications (“DECT”), Bluetooth, derivatives thereof, as well as any other wireless protocols that are designated as 3G, 4G, 5G, and beyond. The computing device 400 may include a plurality of communication chips 406. For instance, a first communication chip 406 may be dedicated to shorter range wireless communications such as Wi-Fi and Bluetooth and a second communication chip 406 may be dedicated to longer range wireless communications such as GPS, EDGE, GPRS, CDMA, WiMAX, LTE, Ev-DO, and others.

In various implementations, the computing device 400 may be a laptop, a netbook, a notebook, an ultrabook, a smart phone, a computing tablet, a personal digital assistant (“PDA”), an ultra mobile PC, a mobile phone, a desktop computer, a server, an embedded computing device, a printer, a scanner, a monitor, a set-top box, an entertainment control unit (e.g., a gaming console), a digital camera, a portable music player, or a digital video recorder, depending on whether computing device 400 is used to implement self-service computing device 100 or mobile computing device 114. In further implementations, the computing device 400 may be any other electronic device that processes data.

Machine-readable media (including non-transitory machine-readable media, such as machine-readable storage media), methods, systems and devices for performing the above-described techniques are illustrative examples of embodiments disclosed herein. Additionally, other devices in the above-described interactions may be configured to perform various disclosed techniques.

### Examples

Example 1 may be directed to at least one non-transitory computer-readable medium including instructions that, in response to execution of the instructions by a self-service computing device, cause the self-service computing device to provide, to a remote computing device in direct wireless communication with the self-service computing device, data for the remote computing device to render an instance of a user interface operable by a user of the remote computing device to select a product or service offered by the self-service computing device.

Example 2 may be directed to the at least one non-transitory computer-readable medium of Example 1, wherein the instructions, in response to execution of the instructions by the self-service computing device, cause the self-service computing device to obtain a user selection from a remote computing server in communication with the remote computing device.

Example 3 may be directed to the at least one non-transitory computer-readable medium of Example 1, wherein the instructions, in response to execution of the instructions by the self-service computing device, cause the self-service computing device to obtain a user selection directly from the remote computing device.

Example 4 may be directed to the at least one non-transitory computer-readable medium of Example 1, wherein provide data includes provide to the remote computing device a URL accessible by the remote computing device to obtain data configured to cause the remote computing device to render the user interface instance.

Example 5 may be directed to the at least one non-transitory computer-readable medium of any one of Examples 1-4, wherein the direct wireless communication includes communication using RFID technology.

Example 6 may be directed to the at least one non-transitory computer-readable medium of any one of Examples 1-4, wherein the direct wireless communication includes NFC.

Example 7 may be directed to the at least one non-transitory computer-readable medium of any one of Examples 1-4, wherein the direct wireless communication is implemented with one or more QR codes.

Example 8 may be directed to the at least one non-transitory computer-readable medium of any one of Examples 1-4, wherein the instructions further cause the self-service computing device, in response to execution of the instructions, to inform a remote computing server of products or services dispensed by the self-service computing device.

Example 9 may be directed to the at least one non-transitory computer-readable medium of any one of Examples 1-4, wherein the instructions further cause the self-service computing device, in response to execution of the instructions, to inform a remote computing server when an inventory of products or services offered by the self-service computing device is below a predetermined threshold.

Example 10 may be directed to the at least one non-transitory computer-readable medium of any one of Examples 1-4, wherein the instructions further cause the self-service computing device, in response to execution of the instructions, to inform a remote computing server of products supplied to the self-service computing device.

Example 11 may be directed to the at least one non-transitory computer-readable medium of any one of Examples 1-4, wherein the remote computing device is a first remote computing device, and wherein the instructions, in response to execution of the instructions by the self-service computing device, cause the self-service computing device to selectively dispense, to a first user of the first remote computing device or a second user of a second remote computing device for which the self-service computing device has provided data for rendition of an instance of the user interface, a product or service selected by both the first and second users.

Example 12 may be directed to the at least one non-transitory computer-readable medium of Example 11, wherein the selectively dispense is based on an order in which the self-service computing device commenced direct wireless communication with the first and second remote computing devices.

Example 13 may be directed to the at least one non-transitory computer-readable medium of Example 11, wherein the selectively dispense is based on an order in which the self-service computing device receives indications that the first and second users have operated respective instances of the user interface to select a product or service offered by the self-service computing device.

Example 14 may be directed to the at least one non-transitory computer-readable medium of Example 11, wherein the selectively dispense is based on an order in which the self-service computing device receives indications that the first and second users have tendered payment for a selected a product or service offered by the self-service computing device.

Example 15 may be directed to the at least one non-transitory computer-readable medium of any one of Examples 1-4, wherein the instructions further cause the self-service computing device, in response to execution of the instructions, to provide, to the remote computing device, data for the remote computing device to render a personalized content, based on characteristics of a user captured by the self-service computing device.

Example 16 may be directed to a computer-implemented method, including: providing, by a self-service computing device, to a remote computing device in direct wireless communication with the self-service computing device, data for the remote computing device to render an instance of a user interface operable by a user of the remote computing device to select a product or service offered by the self-service computing device; and dispensing, by the self-service computing device, a product or service selected by the user with the remote computing device.

Example 17 may be directed to the computer-implemented method of Example 16, further including obtaining, by the self-service computing device, a user selection from a remote computing server in communication with the remote computing device.

Example 18 may be directed to the computer-implemented method of Example 16, further including obtaining, by the self-service computing device, a user selection directly from the remote computing device.

Example 19 may be directed to the computer-implemented method of Example 16, wherein providing includes providing, by the self-service computing device to the remote computing device, a URL accessible by the remote computing device to obtain data configured to cause the remote computing device to render the user interface instance.

Example 20 may be directed to the computer-implemented method of any one of Examples 16-19, wherein the direct wireless communication includes communication using RFID technology.

Example 21 may be directed to the computer-implemented method of any one of Examples 16-19, wherein the direct wireless communication includes NFC.

Example 22 may be directed to the computer-implemented method of any one of Examples 16-19, wherein the direct wireless communication is implemented using one or more QR codes.

Example 23 may be directed to the computer-implemented method of any one of Examples 16-19, further including informing, by the self-service computing device, a remote computing server of products or services dispensed by the self-service computing device.

Example 24 may be directed to the computer-implemented method of any one of Examples 16-19, further including informing, by the self-service computing device, a remote computing server when an inventory of products or services offered by the self-service computing device is below a predetermined threshold.

Example 25 may be directed to the computer-implemented method of any one of Examples 16-19, further including informing, by the self-service computing device, a remote computing server of products supplied to the self-service computing device.

Example 26 may be directed to the computer-implemented method of any one of Examples 16-19, wherein the remote computing device is a first remote computing device, and dispensing includes selectively dispensing, by the self-service computing device to a first user of the first remote computing device or a second user of a second remote computing device for which the self-service computing device has provided data for rendition of an instance of the user interface, a product or service selected by both the first and second users.

Example 27 may be directed to the computer-implemented method of Example 26, wherein the selectively dispensing is based on an order in which the self-service computing device commenced direct wireless communication with the first and second remote computing devices.

Example 28 may be directed to the computer-implemented method of Example 26, wherein the selectively dispensing is based on an order in which the self-service computing device receives indications that the first and second users have operated respective instances of the user interface to select a product or service offered by the self-service computing device.

Example 29 may be directed to the computer-implemented method of Example 26, wherein the selectively dispensing is based on an order in which the self-service computing device receives indications that the first and second users have tendered payment for a selected a product or service offered by the self-service computing device.

Example 30 may be directed to the computer-implemented method of any one of Examples 16-19, further including providing, by the self-service computing device to the remote computing device, data for the remote computing device to render a personalized content, based on characteristics of a user captured by the self-service computing device.

Example 31 may be directed to a self-service system including: one or more computer processors; and a self-service engine coupled to the one or more computer processors and including: a user interface provider module configured to provide, to a remote computing device in direct wireless communication with the self-service system, data for the remote computing device to render an instance of a user interface operable by a user of the remote computing device to select a product or service offered by the self-service system; and a dispenser module configured to dispense a product or service selected by the user with the remote computing device.

Example 32 may be directed to the self-service system of Example 31, wherein the user interface provider module is further configured to obtain a user selection from a remote computing server in communication with the remote computing device.

Example 33 may be directed to the self-service system of Example 31, wherein the user interface provider module is further configured to obtain a user selection directly from the remote computing device.

Example 34 may be directed to the self-service system of Example 31, wherein the user interface provider module is configured to provide, to the remote computing device, a URL accessible by the remote computing device to obtain data configured to cause the remote computing device to render the user interface instance.

Example 35 may be directed to the self-service system of any one of Examples 31-34, further including a RFID interface coupled to the one or more computer processors, wherein the direct wireless communication includes communication through the RFID interface.

Example 36 may be directed to the self-service system of any one of Examples 31-34, further including a NFC interface coupled to the one or more computer processors, wherein the direct wireless communication includes communication through the NFC interface.

Example 37 may be directed to the self-service system of any one of Examples 31-34, further including a QR code interface coupled to the one or more computer processors, wherein the direct wireless communication includes communication through the QR Code interface.

Example 38 may be directed to the self-service system of any one of Examples 31-34, wherein the dispenser module is further configured to inform a remote computing server of products or services dispensed by the self-service system.

Example 39 may be directed to the self-service system of any one of Examples 31-34, wherein the dispenser module is further configured to inform a remote computing server when an inventory of products or services offered by the self-service system is below a predetermined threshold.

Example 40 may be directed to the self-service system of any one of Examples 31-34, wherein the dispenser module is further configured to inform a remote computing server of products supplied to the self-service system.

Example 41 may be directed to the self-service system of any one of Examples 31-34, wherein the remote computing device is a first remote computing device, and the dispenser module is further configured to selectively dispense, to a first user of the first remote computing device or a second user of a second remote computing device for which the self-service system has provided data for rendition of an instance of the user interface, a product or service selected by both the first and second users.

Example 42 may be directed to the self-service system of Example 41, wherein the dispenser module is further configured to selectively dispense based on an order in which the self-service system commenced direct wireless communication with the first and second remote computing devices.

Example 43 may be directed to the self-service system of Example 41, wherein the dispenser module is further configured to selectively dispense based on an order in which the self-service system receives indications that the first and second users have operated respective instances of the user interface to select a product or service offered by the self-service system.

Example 44 may be directed to the self-service system of Example 41, wherein the dispenser module is further configured to selectively dispense based on an order in which the self-service system receives indications that the first and second users have tendered payment for a selected product or service offered by the self-service system.

Example 45 may be directed to the self-service system of any one of Examples 31-34, wherein the user interface provider module is further configured to provide, to the remote computing device, data for the remote computing device to render a personalized content, based on characteristics of a user captured by the self-service system.

Example 46 may be directed to an apparatus including:
means for providing, to a remote computing device in direct wireless communication with the apparatus, data for the remote computing device to render an instance of a user interface operable by a user of the remote computing device to select a product or service offered by the apparatus; and
means for dispensing a product or service selected by the user with the remote computing device.

Example 47 may be directed to the apparatus of Example 46, further including means for obtaining a user selection from a remote computing server in communication with the remote computing device.

Example 48 may be directed to the apparatus of Example 46, further including means for obtaining a user selection directly from the remote computing device.

Example 49 may be directed to the apparatus of Example 46, wherein the means for providing includes means for providing, to the remote computing device, a URL accessible by the remote computing device to obtain data configured to cause the remote computing device to render the user interface instance.

Example 50 may be directed to the apparatus of any one of Examples 46-49, wherein the direct wireless communication includes communication using RFID technology.

Example 51 may be directed to the apparatus of any one of Examples 46-49, wherein the direct wireless communication includes NFC.

Example 52 may be directed to the apparatus of any one of Examples 46-49, wherein the direct wireless communication is implemented with one or more QR codes.

Example 53 may be directed to the apparatus of any one of Examples 46-49, further including means for informing a remote computing server of products or services dispensed by the apparatus.

Example 54 may be directed to the apparatus of any one of Examples 46-49, further including means for informing a remote computing server when an inventory of products or services offered by the apparatus is below a predetermined threshold.

Example 55 may be directed to the apparatus of any one of Examples 46-49, further including means for informing a remote computing server of products supplied to the apparatus.

Example 56 may be directed to the apparatus of any one of Examples 46-49, wherein the remote computing device is a first remote computing device, the apparatus further including means for selectively dispensing, to a first user of the first remote computing device or a second user of a second remote computing device for which the apparatus has provided data for rendition of an instance of the user interface, a product or service selected by both the first and second users.

Example 57 may be directed to the apparatus of Example 56, wherein the means for selectively dispensing includes means for selectively dispensing based on an order in which the apparatus commenced direct wireless communication with the first and second remote computing devices.

Example 58 may be directed to the apparatus of Example 56, wherein the means for selectively dispensing includes means for selectively dispensing based on an order in which the apparatus receives indications that the first and second users have operated respective instances of the user interface to select a product or service offered by the apparatus.

Example 59 may be directed to the apparatus of Example 56, wherein the means for selectively dispensing includes means for selectively dispensing based on an order in which the apparatus receives indications that the first and second users have tendered payment for a selected a product or service offered by the apparatus.

Example 60 may be directed to the apparatus of any one of Examples 46-49, further including means for providing, to the remote computing device, data for the remote computing device to render a personalized content, based on characteristics of a user captured by the self-service computing device.

Example 61 may be directed to at least one non-transitory computer-readable medium including instructions that, in response to execution of the instructions by a mobile computing device, cause the mobile computing device to render an instance of a user interface operable by a user of the mobile computing device to select a product or service offered by a self-service computing device in direct wireless communication with the mobile computing device.

Example 62 may be directed to the at least one non-transitory computer-readable medium of Example 61, wherein the instructions, in response to execution of the instructions by the mobile computing device, cause the mobile computing device to provide a user selection to a remote computing server in communication with the self-service computing device.

Example 63 may be directed to the at least one non-transitory computer-readable medium of Example 61, wherein the instructions, in response to execution of the instructions by the mobile computing device, cause the mobile computing device to provide a user selection directly to the self-service computing device.

Example 64 may be directed to the at least one non-transitory computer-readable medium of Example 61, wherein the instructions further cause the mobile computing device, in response to execution of the instructions, to obtain, from the self-service computing device, a URL accessible by the mobile computing device to obtain data configured to cause the mobile computing device to render the user interface instance.

Example 65 may be directed to the at least one non-transitory computer-readable medium of any one of Examples 61-64, wherein the direct wireless communication includes communication using RFID technology.

Example 66 may be directed to the at least one non-transitory computer-readable medium of any one of Examples 61-64, wherein the direct wireless communication includes NFC.

Example 67 may be directed to the at least one non-transitory computer-readable medium of any one of Examples 61-64, wherein the direct wireless communication is implemented with one or more QR codes.

Example 68 may be directed to the at least one non-transitory computer-readable medium of Example 67, wherein the instructions further cause the mobile computing device, in response to execution of the instructions, to tender payment for a selected product or service to the self-service computing device using NFC.

Example 69 may be directed to the at least one non-transitory computer-readable medium of any one of Examples 61-64, wherein the instructions further cause the mobile computing device, in response to execution of the instructions by the mobile computing device, to render, as part of the user interface instance, a personalized content, based on characteristics of the user captured by the self-service computing device.

Example 70 may be directed to a computer-implemented method, including obtaining, by a mobile computing device from a self-service computing device using direct wireless communication, data associated with a user interface associated with the self-service computing device; and rendering, by the mobile computing device, an instance of the user interface operable by a user of the mobile computing device to select a product or service offered by the self-service computing device.

Example 71 may be directed to the computer-implemented method of Example 70, further including providing, by the mobile computing device, a user selection to a remote computing server in communication with the self-service computing device.

Example 72 may be directed to the computer-implemented method of Example 70, further including providing, by the mobile computing device, a user selection directly to the self-service computing device.

Example 73 may be directed to the computer-implemented method of Example 70, wherein the obtained data includes a URL accessible by the mobile computing device to obtain data configured to cause the mobile computing device to render the user interface instance.

Example 74 may be directed to the computer-implemented method of any one of Examples 70-73, wherein the direct wireless communication includes communication using RFTD technology.

Example 75 may be directed to the computer-implemented method of any one of Examples 70-73, wherein the direct wireless communication includes NFC.

Example 76 may be directed to the computer-implemented method of any one of Examples 70-73, wherein the direct wireless communication is implemented with one or more QR codes.

Example 77 may be directed to the computer-implemented method of any one of Examples 70-73, further including tendering, by the mobile computing device, payment for a selected product or service to the self-service computing device using NFC.

Example 78 may be directed to the computer-implemented method of any one of Examples 70-73, further including rendering, by the mobile computing device as part of the user interface instance, a personalized content, based on characteristics of the user captured by the self-service computing device.

Example 79 may be directed to a mobile computing device, including: one or more computer processors; a wireless interface coupled to the one or more processors; and a user interface implementation module coupled to the one or more computer processors and configured to render an instance of a user interface operable by a user of the mobile computing device to select a product or service offered by a self-service computing device in direct wireless communication with the mobile computing device via the wireless interface.

Example 80 may be directed to the mobile computing device of Example 79, wherein the user interface implementation module is further configured to provide a user selection to a remote computing server in communication with the self-service computing device.

Example 81 may be directed to the mobile computing device of Example 79, wherein the user interface implementation module is further configured to provide a user selection directly to the self-service computing device via the wireless interface.

Example 82 may be directed to the mobile computing device of Example 79, wherein the user interface implementation module is further configured to obtain, from the self-service computing device, a URL accessible by the mobile computing device to obtain data configured to cause the user interface implementation module to render the user interface instance.

Example 83 may be directed to the mobile computing device of any one of Examples 79-82, wherein the direct wireless communication includes communication using RFID technology and the wireless interface includes an RFID interface.

Example 84 may be directed to the mobile computing device of any one of Examples 79-82, wherein the direct wireless communication includes NFC and the wireless interface includes an NFC interface.

Example 85 may be directed to the mobile computing device of any one of Examples 79-82, wherein the direct wireless communication includes communication with one or more QR codes.

Example 86 may be directed to the mobile computing device of Example 87, further including a payment module configured to tender payment for a selected product or service to the self-service computing device using the NFC interface.

Example 87 may be directed to the mobile computing device of any one of Examples 79-82, wherein the user interface implementation module is further configured to render, as part of the user interface instance, a personalized content, based on characteristics of the user captured by the self-service computing device.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1.-25. (canceled)

26. At least one non-transitory computer-readable medium comprising instructions that, in response to execution of the instructions by a self-service computing device, cause the self-service computing device to provide, to a remote computing device in direct wireless communication with the self-service computing device, data for the remote computing device to render an instance of a user interface operable by a user of the remote computing device to select a product or service offered by the self-service computing device.

27. The at least one non-transitory computer-readable medium of claim 26, wherein the instructions, in response to execution of the instructions by the self-service computing device, cause the self-service computing device to obtain a user selection from a remote computing server in communication with the remote computing device.

28. The at least one non-transitory computer-readable medium of claim 26, wherein the instructions, in response to execution of the instructions by the self-service computing device, cause the self-service computing device to obtain a user selection directly from the remote computing device.

29. The at least one non-transitory computer-readable medium of claim 26, wherein provide data comprises provide to the remote computing device a universal resource locator (“URL”) accessible by the remote computing device to obtain data configured to cause the remote computing device to render the user interface instance.

30. The at least one non-transitory computer-readable medium of claim 26, wherein the direct wireless communication comprises communication using radio frequency identification (“RFID”) technology.

31. The at least one non-transitory computer-readable medium of claim 26, wherein the direct wireless communication comprises near field communication (“NFC”).

32. The at least one non-transitory computer-readable medium of claim 26, wherein the direct wireless communication is implemented with one or more quick response (“QR”) codes.

33. The at least one non-transitory computer-readable medium of claim 26, wherein the instructions further cause the self-service computing device, in response to execution of the instructions, to inform a remote computing server of products or services dispensed by the self-service computing device.

34. The at least one non-transitory computer-readable medium of claim 26, wherein the instructions further cause the self-service computing device, in response to execution of the instructions, to inform a remote computing server when an inventory of products or services offered by the self-service computing device is below a predetermined threshold.

35. The at least one non-transitory computer-readable medium of claim 26, wherein the instructions further cause the self-service computing device, in response to execution of the instructions, to inform a remote computing server of products supplied to the self-service computing device.

36. The at least one non-transitory computer-readable medium of claim 26, wherein the remote computing device is a first remote computing device, and wherein the instructions, in response to execution of the instructions by the self-service computing device, cause the self-service computing device to selectively dispense, to a first user of the first remote computing device or a second user of a second remote computing device for which the self-service computing device has provided data for rendition of an instance of the user interface, a product or service selected by both the first and second users.

37. The at least one non-transitory computer-readable medium of claim 36, wherein the selectively dispense is based on an order in which the self-service computing device commenced direct wireless communication with the first and second remote computing devices.

38. The at least one non-transitory computer-readable medium of claim 36, wherein the selectively dispense is based on an order in which the self-service computing device receives indications that the first and second users have operated respective instances of the user interface to select a product or service offered by the self-service computing device.

39. The at least one non-transitory computer-readable medium of claim 36, wherein the selectively dispense is based on an order in which the self-service computing device receives indications that the first and second users have tendered payment for a selected a product or service offered by the self-service computing device.

40. The at least one non-transitory computer-readable medium of claim 26, wherein the instructions further cause the self-service computing device, in response to execution of the instructions, to provide, to the remote computing device, data for the remote computing device to render a personalized content, based on characteristics of a user captured by the self-service computing device.

41. A self-service system comprising:
one or more computer processors; and
a self-service engine coupled to the one or more computer processors and comprising:
a user interface provider module configured to provide, to a remote computing device in direct wireless communication with the self-service system, data for the remote computing device to render an instance of a user interface operable by a user of the remote computing device to select a product or service offered by the self-service system; and
a dispenser module configured to dispense a product or service selected by the user with the remote computing device.

42. The self-service system of claim 41, further comprising a radio frequency identification (“RFID”) interface coupled to the one or more computer processors, wherein the direct wireless communication comprises communication through the RFID interface.

43. The self-service system of claim 41, further comprising a near field communication (“NFC”) interface coupled to the one or more computer processors, wherein the direct wireless communication comprises communication through the NFC interface.

44. The self-service system of claim 41, further comprising a quick response (“QR”) code interface coupled to the one or more computer processors, wherein the direct wireless communication comprises communication through the QR code interface.

45. The self-service system of claim 41, wherein the dispenser module is further configured to inform a remote computing server of products or services dispensed by the self-service system, and/or inform the remote computing server when an inventory of products or services offered by the self-service system is below a predetermined threshold.

46. The self-service system of claim 41, wherein the remote computing device is a first remote computing device, and the dispenser module is further configured to selectively dispense, to a first user of the first remote computing device or a second user of a second remote computing device for which the self-service system has provided data for rendition of an instance of the user interface, a product or service selected by both the first and second users.

47. The self-service system of claim 46, wherein the dispenser module is further configured to selectively dispense based on an order in which the self-service system commenced direct wireless communication with the first and second remote computing devices, an order in which the self-service system receives indications that the first and second users have operated respective instances of the user interface to select a product or service offered by the self-service system, or an order in which the self-service system receives indications that the first and second users have tendered payment for a selected product or service offered by the self-service system.

48. At least one non-transitory computer-readable medium comprising instructions that, in response to execution of the instructions by a mobile computing device, cause the mobile computing device to render an instance of a user interface operable by a user of the mobile computing device to select a product or service offered by a self-service computing device in direct wireless communication with the mobile computing device, wherein the direct wireless communication comprises communication using radio frequency identification (“RFID”) technology or near field communication (“NFC”).

49. The at least one non-transitory computer-readable medium of claim 48, wherein the instructions, in response to execution of the instructions by the mobile computing device, cause the mobile computing device to provide a user selection to a remote computing server in communication with the self-service computing device, or directly to the self-service computing device.

50. The at least one non-transitory computer-readable medium of claim 48, wherein the instructions further cause the mobile computing device, in response to execution of the instructions, to obtain, from the self-service computing device, a universal resource locator (“URL”) accessible by the mobile computing device to obtain data configured to cause the mobile computing device to render the user interface instance.
